(19) United States
(12) Patent Application Publication
(10) Pub. No.: US 2012/0019858 A1
(43) Pub. Date: Jan. 26, 2012

(54) Hand-Held Device and Apparatus Management Method

(76) Inventor: Tomonori Sato, Tokyo (JP)

(21) Appl. No.: 13/183,162

(22) Filed: Jul. 14, 2011

(30) Foreign Application Priority Data
Jul. 26, 2010 (JP) JP2010-167424

(51) Int. Cl. G06F 3/12

(52) U.S. Cl. 358/1.15

(57) ABSTRACT

A hand-held device provided with a display section including a position identifying section for identifying the position of a hand-held device; an orientation identifying section for identifying an orientation of the hand-held device; and a control section that specifies a prescribed managed apparatus located within a prescribed range of distance from a hand-held device and in a specific direction of the hand-held device, based on the pre-stored position information on one or plural managed apparatuses, and acquires the status information showing the status of the aforementioned prescribed managed apparatus to display this status information on the display section. Further, an image pick-up section is provided to capture an image in the specific direction. The control section controls the display section to display an image formed by superimposing the aforementioned status information onto the image of the prescribed managed apparatus captured by the image pick-up section.

This application is based on Japanese Patent Application No. 2010-167424 filed on Jul. 26, 2010 with Japanese Patent Office, the entire content of which is hereby incorporated by reference.

### BACKGROUND OF THE INVENTION

The present invention relates to a hand-held device and apparatus management method, particularly to a hand-held device having a function of identifying the position and orientation, and a status display and operation method for the image forming apparatus by using the aforementioned hand-held device.

There has been a widespread use of image forming apparatuses (MFPs: Multi Function Peripherals) provided with a copying function, printing function and scanning function. In a business office, a plurality of image forming apparatuses are linked to a network, and the printed copies are given from an image forming apparatus selected by a user.

In such a system, when the image forming apparatus specified by the user is employed by another user, the printing operation is deferred until the job of the other user completes. To avoid this, prior to transmission of a job, the user is required to know which image forming apparatus is currently in the process of executing a job, and which an image forming apparatus which is ready to print. In the conventional technology, the user has to move to the place where the panel of an image forming apparatus is visible, and to check the panel display. This has taken time and labor.

Another conventional technology is found in the method of the PageScope WebConnection (by Konica Minolta Business Technologies, Inc., Tokyo, Japan) where a web browser is used to display the status of the image forming apparatus remotely. This method requires an IP (Internet Protocol) address for the image forming apparatus as a connection URL (Uniform Resource Locator). When the statuses of plural image forming apparatuses are required to be known at one time, it is necessary to access each of the image forming apparatuses. This method fails to achieve simple and easy viewing of the statuses of the image forming apparatuses.

A further method is found in the Japanese Unexamined Patent Application Publication No. 2004-234218, which discloses an image forming and processing system for forming an image by an image forming apparatus in conformance to the data transmitted from a hand-held device capable of communicating with a server device by wireless means. This server device includes search means for searching for an image forming apparatus on the network, which is present close to the hand-held device, in response to the request of the hand-held device; generation means for generating the data that can be viewed through the hand-held device for displaying a map image showing the position of the image forming apparatus searched out by the aforementioned search means; notification means for notifying the hand-held device of the identification information for identifying the data generated by the aforementioned generation means; and transmission means for sending the data generated by the aforementioned generation unit to the hand-held device, in response to the request for access to the data specified by the aforementioned identification information. In this image forming and processing system, an image is formed by the image forming apparatus specified by the hand-held device, out of the image forming apparatuses shown in the map image.

The method disclosed in the aforementioned Japanese Unexamined Patent Application Publication No. 2004-234218 displays the map image indicating the position of image forming apparatuses on the hand-held device, and ensures understanding of the positional relationship between the hand-held device for data transmission and the surrounding image forming apparatuses. However, this method requires underastanding of the positional relationship between the hand-held device and image forming apparatus on a two-dimensional map, and has raised difficulties in identifying the direction toward the image forming apparatus. Further, there is a restriction to the information that can be displayed on the map. Thus, this method has been accompanied by problems in understanding the statuses of the image forming apparatuses.

### SUMMARY

In view of the problems described above, one of the major objects of the present invention is to provide a hand-held device and apparatus management method for intuitively understandable statuses of a managed apparatus such as an image forming apparatus.

Another object of the present invention is to provide a hand-held device and apparatus management method capable of improving the maneuverability of a managed apparatus such as an image forming apparatus.

To achieve at least one of the aforementioned objects, a hand-held device reflecting one aspect of the present invention includes a display section; a position identifying section for identifying a position of the hand-held device; an orientation identifying section for identifying an orientation of the hand-held device; and a control section which specifies a prescribed managed apparatus located within a prescribed range of distance from the hand-held device and in a specific direction of the hand-held device, based on information stored in advance on positions of one or a plurality of managed apparatuses, and which acquires status information indicating a status of the prescribed managed apparatus to display the status information on the display section.

It is preferable that the aforementioned hand-held device is further provided with an image pick-up section for capturing an image in the specific direction of the hand-held device and the control section controls the display section to display an image which has been formed by superimposing the status information on an image of the prescribed managed apparatus captured by the image pick-up section.

Further, it is preferable that, once the prescribed managed apparatus is not located within the prescribed range of distance from the hand-held device and in the specific direction of the hand-held device as a result of moving the hand-held device, the control section deletes the status information displayed on the display section.

Still further, it is preferable that, after displaying the status information on the display section, the control section controls the display section to display an operation panel for operating the prescribed managed apparatus.

### BRIEF DESCRIPTION OF THE DRAWINGS

FIG. 1 is a diagram representing an example of the structure of a control system related to one example of the present invention.

FIG. 2 is a block diagram representing the structure of an AR server related to one example of the present invention.

FIG. 3 is a block diagram representing the structure of a hand-held device related to one example of the present invention.

FIG. 4 is a block diagram representing the structure of an image forming apparatus related to one example of the present invention.

FIG. 5 is a diagram representing the conceptual image of an AR (Augmented Reality) application on the hand-held device related to one example of the present invention.

FIG. 6 is a diagram representing an example of a screen (status display screen) displayed on the hand-held device related to one example of the present invention.

FIG. 7 is a diagram representing an example of a screen (status display screen) displayed on the hand-held device related to one example of the present invention.

Each of FIGS. 8a and 8b is a diagram representing an example of the information (status display screen status display section) displayed on the hand-held device related to one example of the present invention.

FIG. 9 is a diagram representing an example of a screen (iconized status display screen) displayed on the hand-held device related to one example of the present invention.

FIG. 10 is a diagram representing an example of a screen (status display screen for plural image forming apparatuses) displayed on the hand-held device related to one example of the present invention.

FIG. 11 is a diagram representing an example of a screen (remote operation screen: function selection) displayed on the hand-held device related to one example of the present invention.

FIG. 12 is a diagram representing an example of a screen (remote operation screen: printing file selection) displayed on the hand-held device related to one example of the present invention.

FIG. 13 is a diagram representing an example of a screen (remote operation screen: print setting) displayed on the hand-held device related to one example of the present invention.

FIG. 14 is a diagram representing an example of the management table data stored in the AR server related to one example of the present invention.

FIG. 15 is a diagram representing the conceptual image of a method for identifying the position by the intensity of electric field.

FIGS. 16a-16c are diagrams representing a method for calculating the position for superimposition of the status information.

FIG. 17 is a sequential diagram showing the operation (superimposition and display of status information) of the control system related to one example of the present invention.

FIG. 18 is a flow chart showing the operation (superimposition and display of status information) of the hand-held device related to one example of the present invention.

FIG. 19 is a sequential diagram showing the operation (image forming apparatus remote operation) of the control system related to one example of the present invention.

FIGS. 20a and 20b are flow charts showing the operation (image forming apparatus remote operation) of the hand-held device related to one example of the present invention.

### DETAILED DESCRIPTION OF THE PREFERRED EMBODIMENT

As described in the BACKGROUND, in a system where plural image forming apparatuses are linked with a network as in a business office, there are requirements to ensure easy identification of the statuses of each image forming apparatus. To meet this requirement, a proposal has been made of the method where an image forming apparatus on a map is displayed to ensure easy identification of the statuses. However, this conventional method allows only a limited amount of information to be displayed, and is accompanied with difficulties in finding out the actual location of an image forming apparatus illustrated on a two-dimensional map.

To solve this problem, in one embodiment of the present invention, an image forming apparatus located in a specific direction (angle of view of a camera) from the hand-held device is specified among the image forming apparatuses around the hand-held device, and the status of the specified image forming apparatus and the operation panel for operating the image forming apparatus are superimposed and displayed on the screen (a live view image captured by the camera). This is intended to permit intuitive understanding of the status of the image forming apparatus and operation of the image forming apparatus.

It should be noted that there is a technology of augmented reality where the information having been uploaded by a user through association with position data is superimposed into an image manipulated by a smart phone camera, as in the Sekai Camera. However, there is no conventional technology comparable to that of the present invention where the status of the image forming apparatus is displayed on a real-time basis and the image forming apparatus is operated.

### Example

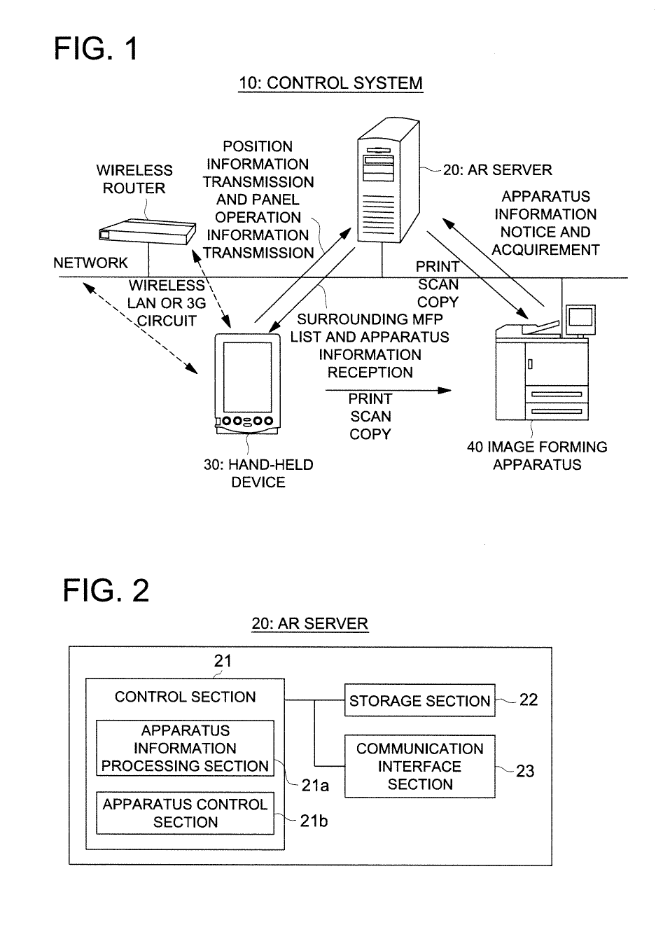

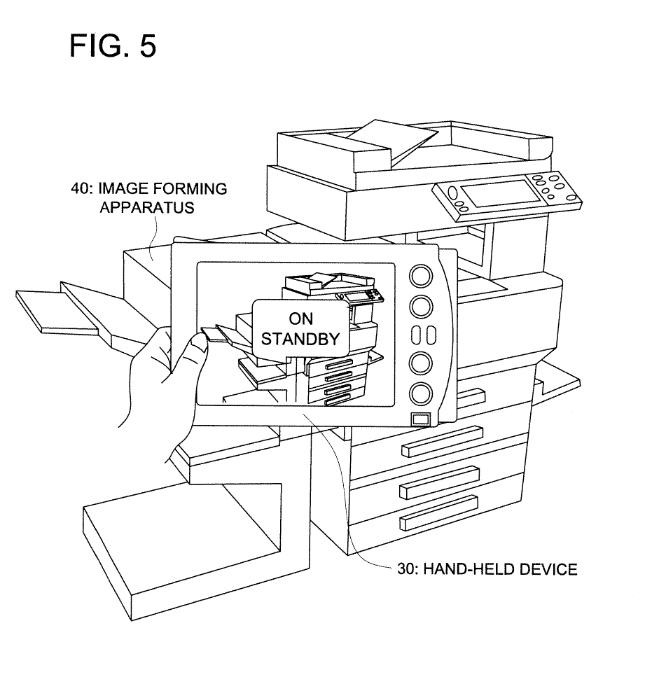

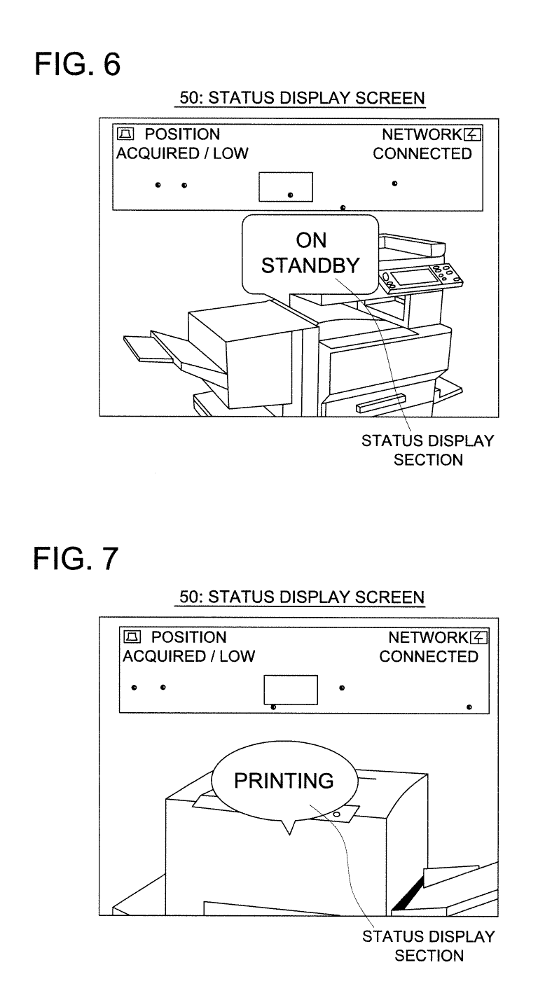

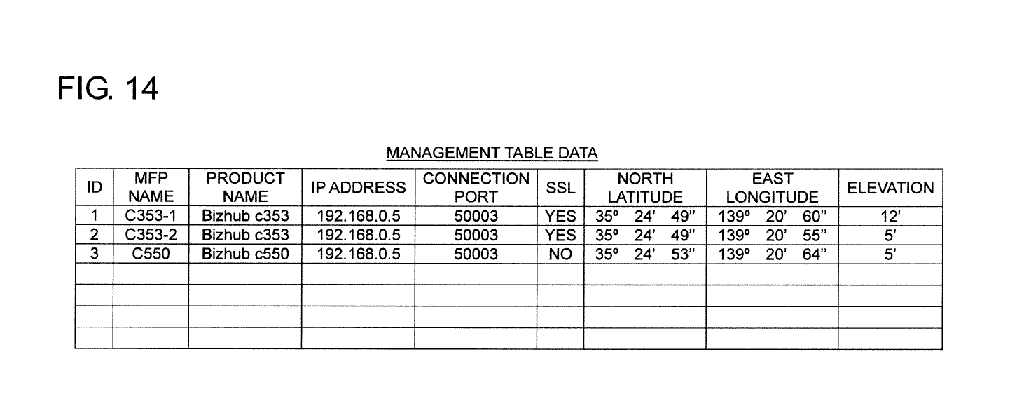

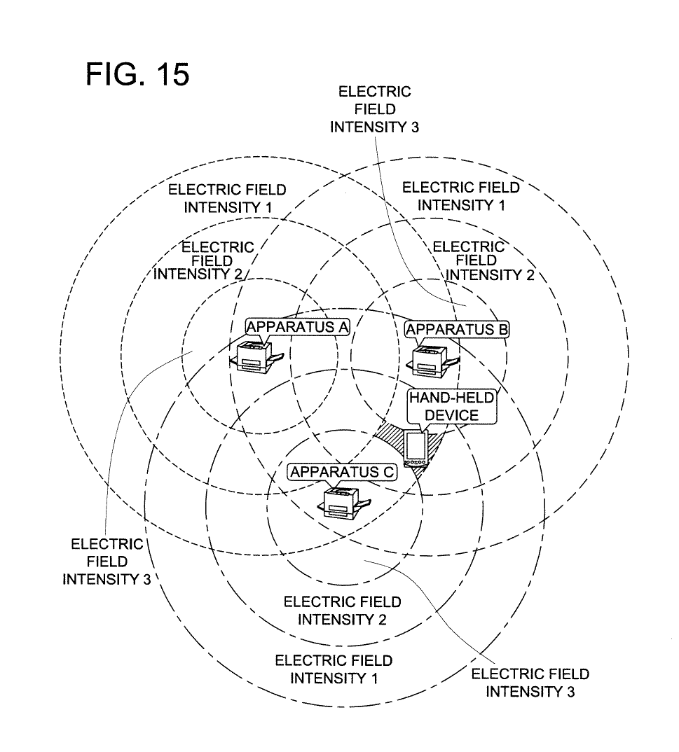

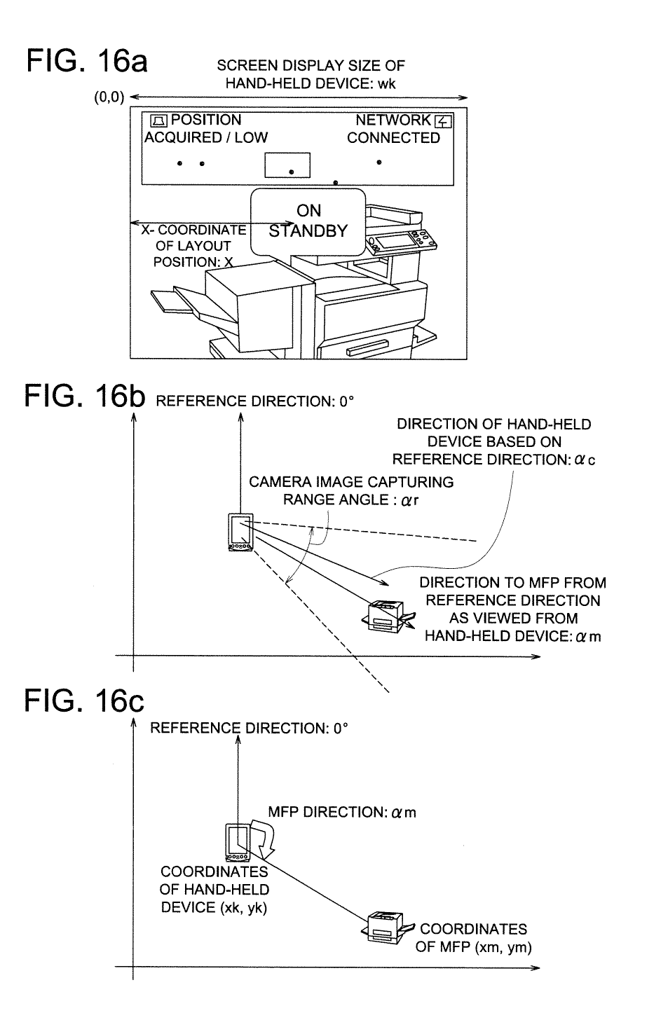

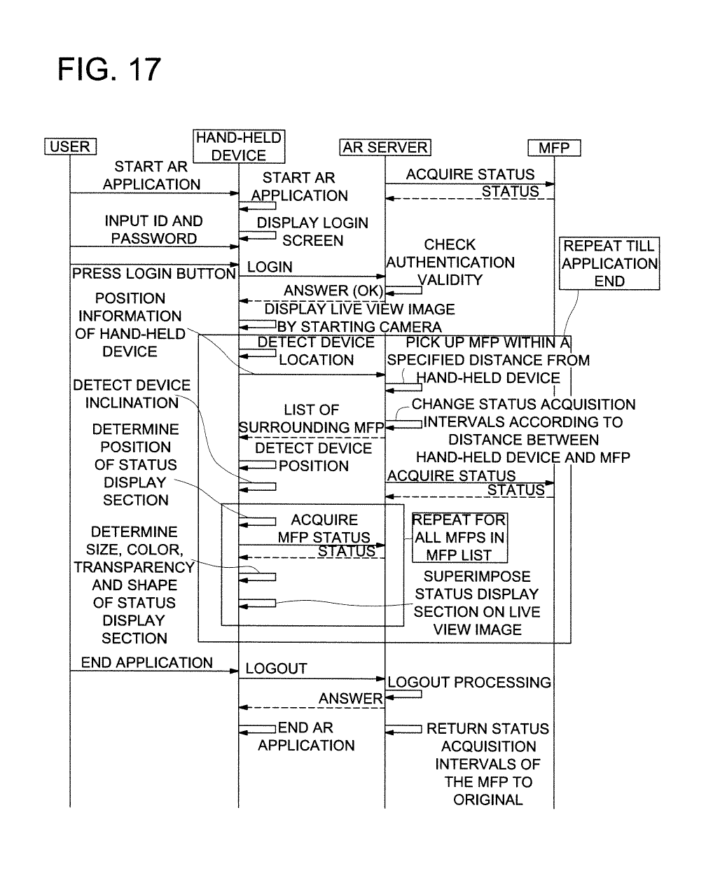

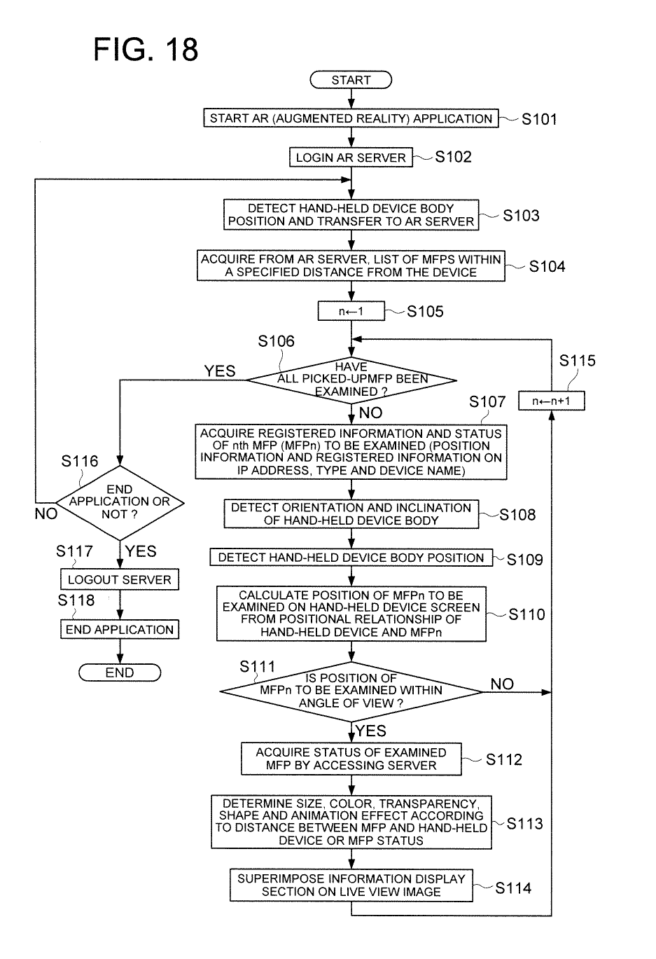

To describe the further details of the aforementioned embodiment of the present invention, the following describes the hand-held device and apparatus management method related to one example of the present invention with reference to FIGS. 1 through 20. FIG. 1 is a diagram representing an example of the structure of a control system in the present example and FIGS. 2 through 4 are block diagrams representing the structures of the AR server, hand-held device and image forming apparatus. Further, FIG. 5 is a diagram representing the conceptual image of an augmented reality application on the hand-held device. FIGS. 6 through 13 show examples of the hand-held device display screens. FIG. 14 shows an example of the management table data stored in the AR server. FIG. 15 shows the conceptual image of a method for identifying the position of the hand-held device from the intensity of electric field. FIGS. 16a-16c show the method for calculating the position for superimposition of the status information. FIGS. 17 through 19 are sequential diagrams showing the operation of the control system in the present example. FIGS. 18 through 20c are flow charts showing the operation of the hand-held device in the present example.

As shown in FIG. 1, the control system 10 of the present example includes an AR (Augmented Reality) server 20, a hand-held device 30 such as a smart phone, mobile telephone or PDA (Personal Digital Assistant), and an image forming apparatus 40 such as an MFP. These components are connected to the network such as a LAN (Local Area Network) or WAN (Wide Area Network), wherein the hand-held device 30 is connected to the network via a wireless router or wireless base station. The following describes the details of the structure of each device:

### [AR Server]

As illustrated in FIG. 2, the AR server 20 includes a control section 21, storage section 22 and communication interface section 23.

The control section 21 is composed of a CPU (Central Processing Unit), a memory such as a RAM (Random Access Memory) and a ROM (Read Only Memory), and provides overall control of the AR server 20. Further, the control section 21 serves the functions of an apparatus information processing section 21a that acquires the information denoting the status of the apparatus (referred to as status information) from the image forming apparatus 40, further acquires the position information from the hand-held device 30, identifies the image forming apparatuses 40 located around the hand-held device 30 (within the prescribed range of distance from the hand-held device 30), sends the list of the image forming apparatuses 40 (referred to as a surrounding MFP list), and further sends the status information of the image forming apparatuses 40 to the hand-held device 30. The control section 21 also serves the functions of the apparatus control section 21b that acquires information on functions and settings (referred to as the function information) from the image forming apparatus 40, sends the function information to the hand-held device 30, acquires the information on the instruction to be given to the image forming apparatus 40, from the hand-held device 30, and executes the operation instruction of which is given to the image forming apparatus 40 in conformance to this instruction information.

The storage section 22 is made up of an HDD (Hard Disk Drive) and others, and stores the management table data in which the position information of each image forming apparatus 40 is described, as well as the real data described in the PDL (Page Description Language) such as the PCL (Printer Control Language) and PS (PostScript®).

The communication interface section 23 is an interface such as the NIC (Network Interface Card) and modem, and communicates with the hand-held device 30 and image forming apparatus 40 in conformance to the ethernet standards and others.

### [Hand-Held Device]

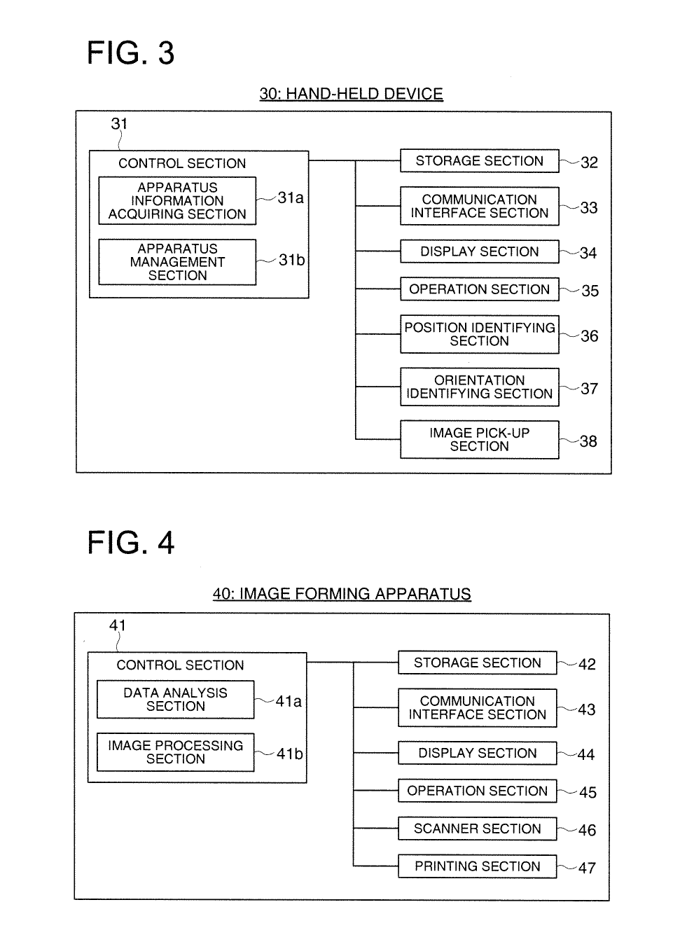

As shown in FIG. 3, the hand-held device 30 includes a control section 31, storage section 32, communication interface section 33, display section 34, operation section 35, position identifying section 36, orientation identifying section 37 and image pick-up section 38.

The control section 31 includes such memories as a CPU, RAM and ROM, and provides overall control of the hand-held device 30. Further, the control section 31 serves the functions of an apparatus information acquiring section 31a that sends the position information of the hand-held device to the AR server 20, acquires from the AR server 20 the surrounding MFP list of the image forming apparatuses 40 around the hand-held device, and further acquires the status information and function information of the image forming apparatus (collectively called the apparatus information). The control section 31 also serves the functions of the apparatus management section 31b that superimposes the status information on the screen of the display section 34 to permit verification of the status of the image forming apparatus 40, creates an operation panel in conformity to the function information and superimposes it on the screen of the display section 34 to permit remote operation of the image forming apparatus 40. It should be noted that the aforementioned functions of the apparatus information acquiring section 31a and apparatus management section 31b can be implemented by means of hardware or a program that allows the control section 31 to work as the apparatus information acquiring section 31a and apparatus management section 31b (referred to as the AR application).

The storage section 32 is formed of an HDD and others, and stores the surrounding MFP list and apparatus information obtained from the AR server 20.

The communication interface section 33 is an interface such as a NIC and modem. Linked to the network via a wireless router or wireless base station, the communication interface section 33 communicates with the AR server 20 and image forming apparatus 40.

The display section 34 is an LCD (Liquid Crystal Display) or organic EL (electroluminescence) display, and is used to show the screen formed by superimposition of status information or the screen formed by superimposition of an operation panel.

The operation section 35 is a hard key or a touch panel on the display section 34. In response to the operation on the displayed operation panel, the operation section 35 permits various forms of instructions given to the image forming apparatus 40.

The position identifying section 36 uses the GPS (Global Positioning System) to identify the position (coordinates) of the hand-held device. Using the self-contained positioning technology consisting of gyro and acceleration sensor, the orientation identifying section 37 identifies the orientation of the hand-held device. It should be noted that, if an electromagnetic wave (waveform specified by the codes of the wireless LAN, Wi-Fi (Wireless Fidelity) or Bluetooth) is issued by the image forming apparatus 40 whose position has been identified and the hand-held device 30 is capable of receiving this electromagnetic wave, it is possible for the hand-held device 30 to measure the intensity of the electric field issued from the plural image forming apparatuses 40 (preferably three or more), as shown in FIG. 15, and to identify the position (coordinates) or orientation of the hand-held device with respect to the plural image forming apparatuses 40, based on the electric field intensity. Further, it is also possible to arrange a configuration where the image captured by the image pick-up section 38 is analyzed to identify the color, shape and pattern of the image, and the image forming apparatus 40 is identified, thereby identifying the position and orientation of the hand-held device from the position of the image forming apparatus. Further, it is also possible to identify the image of a barcode or similar item such as a QR code attached to the image forming apparatus 40 or recognize the RFID (Radio Frequency Identification) tag or a similar item, and to identify the image forming apparatus 40, thereby identifying the position and orientation of the hand-held device based on the position of the image forming apparatus.

The image pick-up section 38 is made up of a CCD (Charge Coupled Devices) camera or a CMOS (Complementary Metal Oxide Semiconductor) camera, and is used to capture the image of the image forming apparatus 40 and others.

In FIG. 3, the hand-held device 30 is provided with an image pick-up section 38. However, if there is no need of superimposing the status information or operation panel onto the image captured by the image pick-up section 38, the image pick-up section 38 need not be provided.

### [Image Forming Apparatus]

As shown in FIG. 4, the image forming apparatus 40 includes a control section 41, storage section 42, communication interface section 43, display section 44, operation section 45, scanner section 46 and printing section 47.

The control section 41 is composed of such a memory as a CPU, RAM and ROM, and provides overall control of the image forming apparatus 40. Further, the control section 41 also serves the functions of a data analysis section for analyzing the real data described in the PCL or PDL, and an image processing section for generating the image data by rasterization (bit map development) of the real data based on the result of analysis.

The storage section 42 is formed of an HDD and others, and stores the real data, image data and various forms of setting information.

The communication interface section 43 is an interface such as the NIC and modem, and communicates with the AR server 20 or hand-held device 30 in conformance to the ethernet standards and others.

The display section 44 includes an LCD or organic EL display, and displays various forms of screens to implement the functions of copying, scanning, printing and faxing.

The operation section 45 is a hard key or a touch panel on the display section 44, and gives various instructions on the functions of copying, scanning, printing and faxing.

The scanner section 46 optically reads the image data from the document on the document platen, and includes a light source for scanning of the document, an image sensor such as a CCD for converting the light reflected from the document into electric signals, and an analog-to-digital converter for analog-to-digital conversion of the electric signals.

The printing section 47 transfers image of the image data onto paper sheet. To put it more specifically, the light in conformity to the image is applied from the exposure device to the photoreceptor drum electrically charged by the charging device, and an electrostatic latent image is formed. This image is developed by attaching the charged toner thereto in the development device, and this toner image is primarily transferred to the transfer belt. Further, this image is secondarily transferred from the transfer belt to the paper medium, and the toner image is fixed onto the paper medium by a fixing device. Further, when required, processing such as folding, book binding and stapling is performed.

In the present example, the control section 21 of the AR server 20 identifies the image forming apparatuses 40 around the hand-held device 30. It is also possible to make such arrangements that the position information of the image forming apparatuses 40 is stored in the hand-held device 30, and the control section 31 of the hand-held device 30 specifies the image forming apparatus 40 located around the hand-held device and in the specific direction therefrom. In the present example, the AR server 20 acquires the status information and function information from the image forming apparatus 40. It is also possible to adopt such a structure that the hand-held device 30 acquires such information directly from the image forming apparatus 40. Further, in the present example, the AR server 20 gives the processing instruction to the image forming apparatus 40. The hand-held device 30 may give processing instruction directly to the image forming apparatus 40. As described above, when the hand-held device 30 is provided with the function of the control section 21 of the AR server 20, there is no need to provide an AR server 20.

The following describes the basic operation of the control system 10 having the aforementioned structure. In the following description, it is assumed that the information on each image forming apparatus 40 (e.g., registered name on the network, product name, IP address, connection port, possibility of SSL (Secure Socket Layer) communication), and the position information (e.g., latitude, longitude and elevation) of each image forming apparatus 40 are stored as a management table data shown in FIG. 14, in advance in the storage section 22 of the AR server 20 or others. The position information of this management table data can be registered by the user. Alternatively, if the image forming apparatus 40 is provided with a position identifying function such as a GPS, this position information can be registered by using the position information sent from the image forming apparatus 40. Further alternatively, this position information can also be registered by bringing the hand-held device 30 close to the image forming apparatus 40 and by using the position information sent from the hand-held device 30.

The status information of each image forming apparatus 40 is acquired by periodic access of the AR server 20 to the image forming apparatus 40 connected to the network alternatively (by periodic access of the image forming apparatus 40 to the AR server 20).

If the AR application stored in the hand-held device 30 in advance is started, the position identifying section 36 acquires the position information (coordinates of latitude and longitude) of the hand-held device. The apparatus information acquiring section 31a sends information on the identified position to the AR server 20. For example, assume that the position and orientation are to be identified by using the electric field intensity of the electromagnetic wave emitted from the image forming apparatus 40, and each of three apparatuses A, B and C of the image forming apparatus 40 emits the electromagnetic wave having electric field intensities of 1 through 3 in the region shown by the concentric circle of the drawing, as shown in FIG. 15. Also assume that the electric field intensity of apparatus A is “1”, and that of apparatuses B and C is “2”. In this case, the hand-held device 30 is located in the crosshatched portion of the region. Accordingly, the position (coordinates) of the hand-held device is identified based on the position (coordinates) of each image forming apparatus 40.

When the AR server 20 has acquired the position information from the hand-held device 30, reference is made to the management table data stored in advance, thereby specifying the image forming apparatus 40 located around the hand-held device 30 (wherein the distance from the hand-held device 30 is within a prescribed range). The list of the specified image forming apparatus 40 (surrounding MFP list) is sent to the hand-held device 30.

The hand-held device 30 uses the position identifying section 36 and orientation identifying section 37 to identify the position and orientation of the hand-held device. The hand-held device 30 further specifies the image forming apparatus 40 located around the hand-held device 30 in the specific direction therefrom, out of the image forming apparatuses 40 on the surrounding MFP list, and obtains the status information of that image forming apparatus 40 from the AR server 20. In this example, the surrounding MFP list is acquired from the AR server 20, and the image forming apparatus 40 located around the hand-held device and in the specific direction is specified from the list. However, it is also possible to adopt such a structure that position information and orientation information of the hand-held device are sent to the AR server 20, and the AR server 20 specifies the image forming apparatus 40 located around the hand-held device 30 in the specific direction, whereby the status information of that image forming apparatus 40 is then sent. In this example, after the surrounding MFP list has been acquired, the position identifying section 36 is again used to identify the position of the hand-held device. When the position of the hand-held device 30 is not changed (when only the orientation is changed), only the orientation of the hand-held device may be identified by using the orientation identifying section 37.

When the status information of the image forming apparatus 40 has been acquired from the AR server 20, the apparatus management section 31b makes the display section 34 display the acquired status information. If the relevant image forming apparatus 40 has deviated from the specific direction due to a change in the orientation of the hand-held device 30, the display of the status information turns off. If a new image forming apparatus 40 has been moved into the specific direction, the status information of the new image forming apparatus 40 is displayed. This procedure is repeated. To be more specific, when the hand-held device 30 has been turned 360 degrees, the status information of the image forming apparatuses 40 located in the specific direction is displayed in turn.

There is no particular restriction to the display mode of this status information. The status information can be displayed independently. Alternatively, if the image forming apparatus 40 has been captured by the image pick-up section 38, the status information can be superimposed on the image of the image forming apparatus 40. FIG. 5 shows an example where status information (lettering “ON STANDBY” showing that this image forming apparatus 40 is waiting for a job) is superimposed onto the image of the image forming apparatus 40 captured by the image pick-up section 38. By superimposing the status information on the image of the image forming apparatus 40 (the portion with the status information superimposed thereon is referred to as the status display section), the status of the image forming apparatus 40 can be intuitively understood. Further, FIG. 6 shows an example where the arrangement of the image forming apparatus 40 connected to the network and the range around the hand-held device 30, in addition to the status information, are displayed on the status display screen 50.

In the display mode of FIG. 6, to ensure that the status information is displayed on the image of the image forming apparatus 40, it is required that the x coordinate denoting the position of the status information should be aligned with the x coordinate denoting the center of the image forming apparatus 40 on the screen. The x coordinate of this image forming apparatus is represented by:

x=wk×(αm−(αc−αr/2))/αr

wherein the screen display size (size in the X direction) of the hand-held device 30 is wk as shown in FIG. 16a, and when the specific direction of the hand-held device 30 (upper direction in this case) is the reference direction, the clockwise direction of the image forming apparatus 40 is αm, the angle of view of the camera in the horizontal direction (angle of image capturing range in the range where display is possible, to be precise) is αr, and the image capturing direction of the hand-held device 30 from the reference direction (center of the angle of image capturing range (αr) of camera) is αc, as shown in FIG. 16b.

As shown in FIG. 16c, the aforementioned αm is given by:

αm=180−(tan⁻¹((ym−yk)/(xm−xk))×(360/2π)

wherein the coordinates of the hand-held device 30 are (xk, yk), and those of the image forming apparatus 40 are (xm, ym).

Thus, x is calculated according to the aforementioned equation, and the x coordinate of the displayed position of the status information is set to this value. Then the status information can be superimposed at the center of the image forming apparatus 40.

When determining the position, it is also possible to use the procedure where the image captured by the camera is analyzed on a real-time basis, the shape of the image forming apparatus 40 is recognized, and the accurate position is identified. Alternatively the display position is corrected based on the shape data (on height and width) for each type of the image forming apparatus 40 or the state of mounted options.

The following describes the variations of the display mode of the status information:

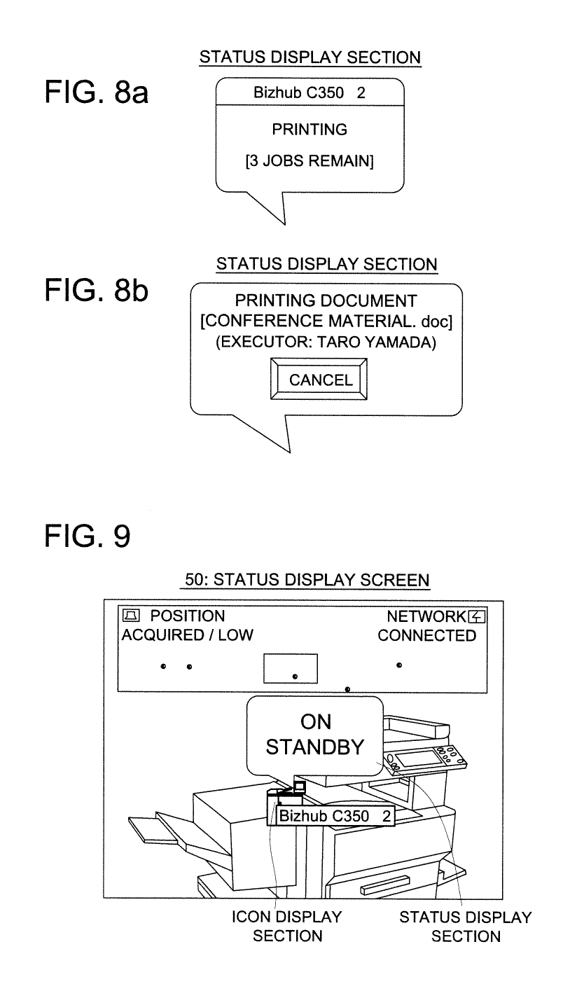

FIG. 6 shows an example where the image forming apparatus 40 is placed in the job standby mode. When the image forming apparatus 40 is executing a job, lettering “PRINTING” is displayed as status information, as shown in FIG. 7. In this case, the number of the remaining jobs or the planned time for job termination can be displayed, as shown in FIG. 8a. Further, the detailed information including the user information on the registered job can be displayed, as shown in FIG. 8b. It is also possible to display an error status, a method for recovery from error, or a guidance showing the operation procedure. Further, to ensure easier identification of the image forming apparatus 40, an icon schematically denoting the image forming apparatus 40 or the name of the image forming apparatus 40 can also be displayed, as shown in FIG. 9.

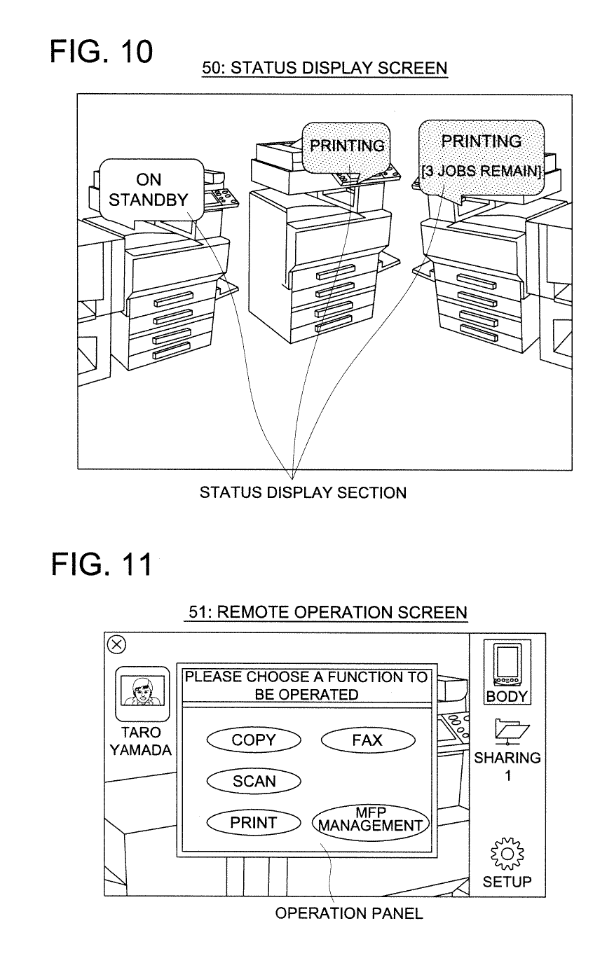

In FIGS. 5 through 9, the status information of one image forming apparatus 40 is displayed on the status display screen 50. However, as shown in FIG. 10, if plural image forming apparatuses 40 are located in the specific direction of the hand-held device 30, the status information of each image forming apparatus 40 can be displayed.

When the aforementioned status information is displayed, the display size of the status information can be changed according to perspective in conformity to distance between the image forming apparatus 40 and hand-held device 30. Further, the color, transparency, size, and animation effect of display can be changed in conformity to the status of the apparatus or the number of the remaining jobs, or the items to be displayed can be changed in conformity to the rights granted to the user or system settings. It is also possible to adopt such a structure that, instead of being displayed for each apparatus, the status is displayed for each job so that job control including suspension of job execution, deletion of job or resumption of job execution can be performed.

FIGS. 5 through 10 show the case where the status information of the image forming apparatus 40 is displayed. If the image forming apparatus 40 is placed in the standby mode according to the status information, this image forming apparatus 40 can be used for processing. It would be a great benefit if the hand-held device 30 can be used for remote control of the image forming apparatus 40. Thus, the AR server 20 can acquire function information from the image forming apparatus 40, and sends it to the hand-held device 30 (or the hand-held device 30 can acquire the function information directly from the image forming apparatus 40). Further, the operation panel for operating the image forming apparatus 40 can be displayed on the display section 33 of the hand-held device 30.

For example, it is also possible to arrange such a configuration that, when the status display screen 50 is used to perform a prescribed operation (e.g., touching of the status display section, or pressing a specific operation button on the hand-held device 30), the remote operation screen 51 obtained by superimposition of the operation panel is displayed on the screen so that copying, scanning, printing, faxing and MFP management are remote-controlled, as shown in FIG. 11.

To put it more specifically, the position of each button of the operation panel on the screen is stored in advance. If the position touched by the user on the screen is matched with the button position, a step is taken to create the instruction information to execute the function of that button, and this instruction information is sent to the image forming apparatus 40 directly or through the AR server 20. The control section 41 of the image forming apparatus 40 allows the function to be executed according to this instruction. It is preferred in this case that only the function that can be used according to the rights granted to the log-in user should be displayed on this operation panel.

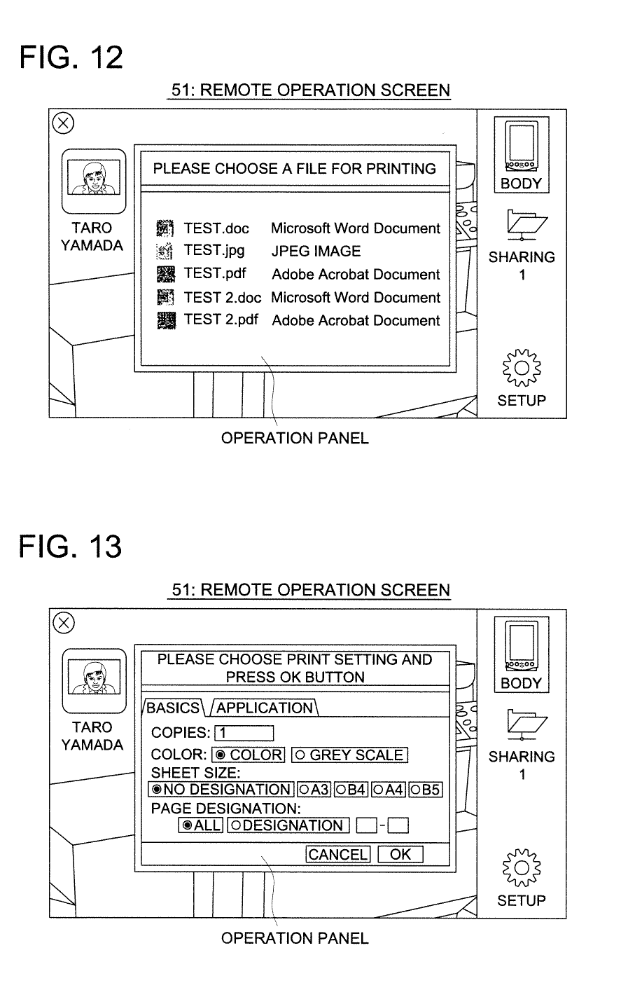

It is also possible to make such arrangements that the documents to be scanned or printed are stored in the pre-registered common server, local disc of the hand-held device 30, and the hard disc built in the image forming apparatus 40, and a screen shown in FIG. 12 is displayed so that the document to be printed can be selected. Alternatively, the screen of FIG. 13 can be shown so that the printing conditions can be set.

The following describes the details of the operation of the control system 10 in the present example.

In the first place, referring to FIGS. 17 and 18, the following describes the steps of superimposing and displaying the status information of the image forming apparatus 40. FIG. 17 is a sequential diagram showing the overall operation of the control system. FIG. 18 is a flow chart showing the operation of the hand-held device 30. In the following description, it is assumed that the management table data for specifying the position of each image forming apparatus 40 is stored in the storage section 22 of the AR server 20 in advance.

The AR server 20 accesses the image forming apparatus 40 at prescribed intervals and acquires the status information from the image forming apparatus 40. This information is then stored in the storage section 22. It is also possible to make such arrangements that each image forming apparatus 40 monitors changes in the status of the image forming apparatus 40. If there is any change in the status, the AR server 20 is notified of the change.

In the meantime, the control section 31 of the hand-held device 30 starts the AR application through the user operation (S101), and the log-in screen appears on the display section 34. If the user has entered an ID and password, and has pressed the log-in button, the control section 31 sends log-in information to the AR server 20, and logs in the AR server 20 (S102).

When required, the control section 31 of the hand-held device 30 starts the image pick-up section 38 to display the live view image on the display section 34. The position identifying section 36 detects the position of the hand-held device (S103), and sends the position information to the AR server 20.

Referring to the management table data stored in advance, the AR server 20 extracts the image forming apparatuses 40 located within a prescribed distance range from the hand-held device 30, and sends the list thereof (surrounding MFP list) to the hand-held device 30. The AR server 20 is preferred to change the intervals of acquiring the status information according to the distance between the hand-held device 30 and image forming apparatus 40 (i.e., to shorten the status information acquisition interval for the image forming apparatus 40 located within a prescribed distance range from the hand-held device 30).

After having acquired the surrounding MFP list from the AR server 20 (S104), the hand-held device 30 obtains registration information of the first image forming apparatus 40 from the surrounding MFP list (S105, 107). Then the position identifying section 36 and orientation identifying section 37 detect the position and orientation of the hand-held device (S108, 109). Based on the position of the first image forming apparatus 40 and the position and orientation of the hand-held device, the control section 31 determines if this image forming apparatus 40 is located in the specific direction of the hand-held device (or if it is located at the position within the angle of view, when the image pick-up section 39 is driven) (S111).

If an image forming apparatus 40 is not present in the specific direction of the hand-held device, the same procedure is repeatedly applied to the next image forming apparatus 40 on the surrounding MFP list (S115). In the meantime, if an image forming apparatus 40 is found in the specific direction of the hand-held device, the control section 31 accesses the AR server 20, and acquires the status information of that image forming apparatus 40 (S112). Then the control section 31 determines the display size, color, transparency, shape and animation effect of the status information in conformity to the distance between the image forming apparatus 40 and hand-held device and the status of the image forming apparatus 40 (S113). The status information is then superimposed on the screen of the display section 34 (a live view image when the image pick-up section 38 is driven) (S114).

After that, the same procedure is repeatedly applies to the next image forming apparatus 40 on the surrounding MFP list (S115). If processing to all the image forming apparatuses 40 on the surrounding MFP list has been completed (Yes in S106), a step is taken to determine whether the AR application has been instructed to terminate or not (S116). If not, the procedure goes back to S103, and the same procedure is repeated. If the AR application has been instructed to terminate, the control section 31 instructs the AR server 20 to logout. Upon receipt of the reply of log-out processing from the AR server 20 (S117), AR application terminates (S118).

As described above, the hand-held device 30 acquires from the AR server 20 the list of the image forming apparatuses 40 located within the prescribed range of distance from the hand-held device. If the image forming apparatus 40 on the list is located in the specific direction of the hand-held device (within the angle of view of the live view image), the hand-held device 30 acquires the status information of the image forming apparatus 40 from the AR server 20, and superimposes and displays it on the screen (live view image). The status of the image forming apparatus 40 located in the vicinity in the corresponding direction can be identified only by directing the hand-held device 30 toward the peripheral areas. This method provides intuitive understanding of the status of image forming apparatuses 40, as compared to the method of displaying the status information on the two-dimensional map.

In the aforementioned flow, the hand-held device 30 sends the position information of the hand-held device to the AR server 20, and the AR server 20 sends the list of the image forming apparatuses 40 located in the vicinity of that hand-held device 30. The hand-held device 30 determines whether or not the image forming apparatuses 40 on the list are located in the specific direction of the hand-held device. However, it is also possible to arrange such a configuration that the hand-held device 30 sends the information on the position and orientation of the hand-held device to the AR server 20. Then the AR server 20 specifies the image forming apparatuses 40 located in the vicinity of that hand-held device 30 in the specific direction, and sends the status information of that image forming apparatus 40.

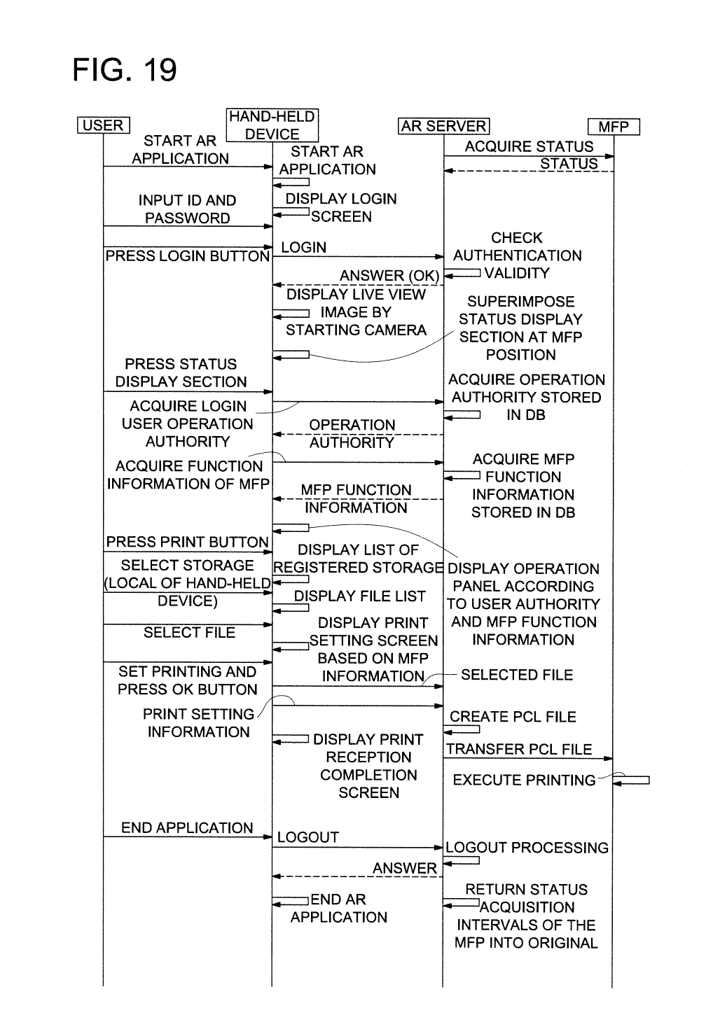

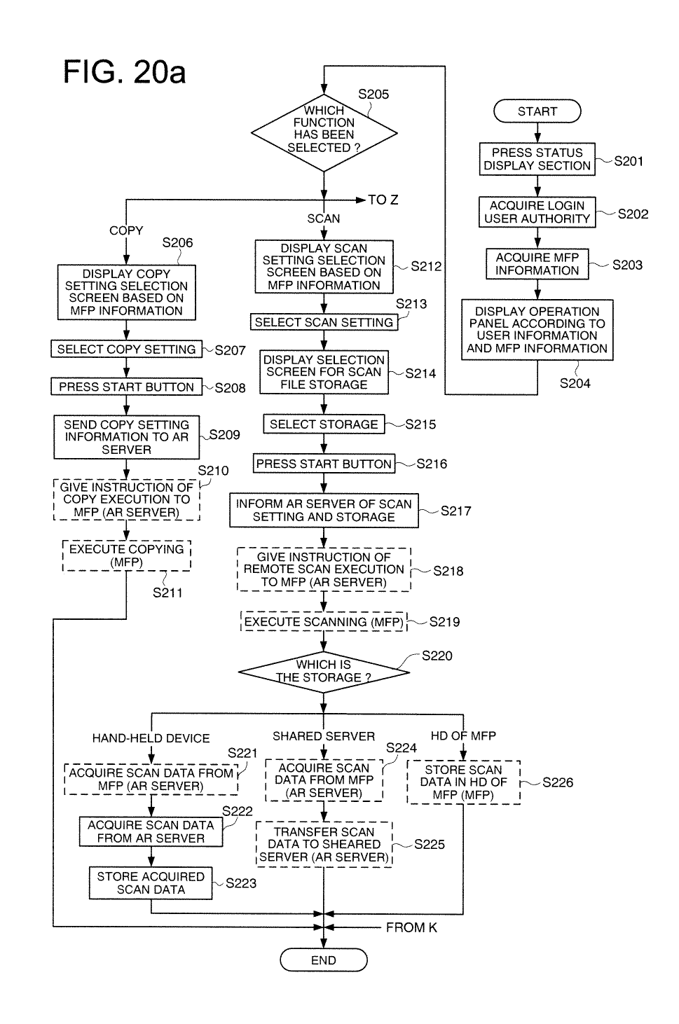

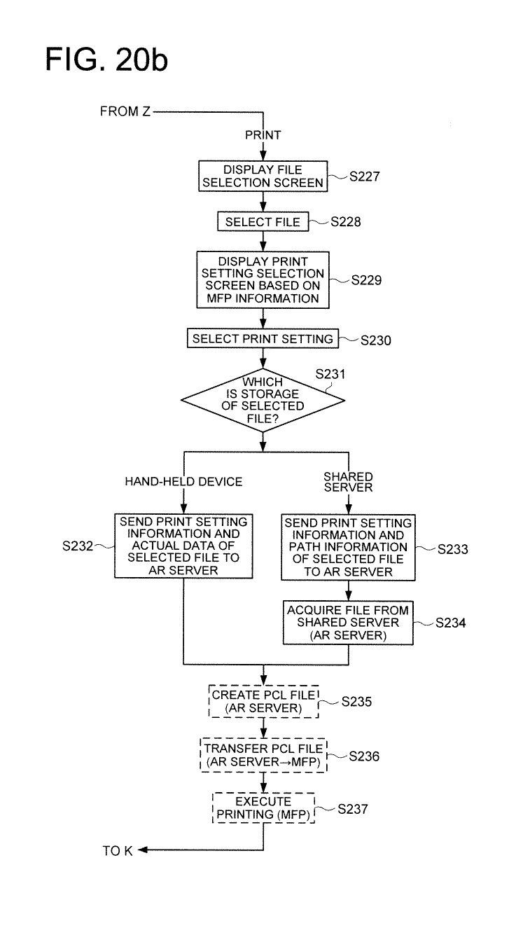

Referring to FIGS. 19, 20a and 20b, the following describes the remote control of the image forming apparatus 40 on the display screen of the hand-held device 30. FIG. 19 is a sequential diagram showing the overall operation of the control system. FIGS. 20a and 20b are flow charts showing the operation of the hand-held device 30.

In the first place, according to the aforementioned flow chart, the status information of the image forming apparatus 40 is superimposed and displayed on the screen (live view image) of the display section 34 of the hand-held device 30. When the user has pressed the status information display area (status display section) (S201), the control section 31 accesses the AR server 20, and acquires the log-in user rights (rights of operation for each function, e.g., for copying, printing, scanning, faxing and management function) from the AR server 20 (S202). It is also possible to make such arrangements that restrictions in terms of the number of times of use and time zone for use are imposed on these rights of operation, or settings are provided for each image forming apparatus 40.

The control section 31 acquires the function information of the image forming apparatus 40 (e.g., possibility of execution of each function, available setting values of each function) from the AR server 20 (S203). The operation panel for remote control of the image forming apparatus 40 shown in FIGS. 11 through 13 is displayed on the display section 34 (S204) according to the information on the rights of the log-in user and the function of the image forming apparatus 40. The “available setting values” refer to the availability of color, n in 1 (plural images in one page), duplex printing, punching or stapling in the printing function; availability of color and resolution in the scanning function; the availability of color, n in 1, duplex printing, punching or stapling in the copying function and availability of faxing in fax transmission function, for example.

The control section 31 identifies the function having been pressed for on the operation panel (S205), and starts processing in conformity to the function pressed for. The following illustrates the case where the copying, scanning and printing functions have been selected.

In the first place, when the Copy button has been pressed on the operation panel, the control section 31 allows the copy setting selection screen to be displayed on the display section 34, based on the function information of the image forming apparatus 40 (S206). If the user has selected the copy setting (S207) and has pressed the Start button (S208), the control section 31 sends the copy setting information to the AR server 20 (S209), and the AR server 20 gives a copy execution instruction to the image forming apparatus 40 according to the copy setting information (S210). This allows the image forming apparatus 40 to perform copying operation (S211). In this configuration, the copy setting information is sent to the AR server 20 from the hand-held device 30, and the AR server 20 gives a copy execution instruction to the image forming apparatus 40. If the hand-held device 30 has a function of communicating with the image forming apparatus 40, the copy execution instruction can be given to the image forming apparatus 40 directly from the hand-held device 30, without using an intermediary of the AR server 20.

When the Scan button has been pressed on the operation panel, the control section 31 allows the scan setting selection screen to be displayed on the display section 34, based on the function information of the image forming apparatus 40 (S212). When the user has selected the scan setting (S213), the control section 31 allows the scan file storage selection screen to be displayed on the display section 34. When the user has selected a storage site on this scan file storage selection screen (S215) and has pressed the Start button (S216), the control section 31 sends the scan setting information and storage site information to the AR server 20 (S217). According to this scan setting information and storage site information, the AR server 20 gives a remote scanning execution instruction to the image forming apparatus 40 (S218). The image forming apparatus 40 then performs scanning (S219). Similarly to the above, when the hand-held device 30 has a function of communicating with the image forming apparatus 40, a remote scanning execution instruction can be given to the image forming apparatus 40 directly from the hand-held device 30, without using an intermediary of the AR server 20.

When the storage site is the hand-held device 30, the AR server 20 acquires scanning data from the image forming apparatus 40 (S221), and the hand-held device 30 acquires the scanning data from the AR server 20 (S222). The acquired scanning is then stored (S223). If the storage site is the common server, the AR server 20 obtains the scanning data from the image forming apparatus 40 (S224), and sends the scanning data to the common server (S225). If the storage site is the HDD of the image forming apparatus 40, the scanning data is stored in the HDD (S226).

Further, when the Print button has been pressed on the operation panel, the control section 31 allows the file selection screen to be displayed on the display section 34 (S227). When the user has selected a file (S228), the control section 31 allows the print setting selection screen to be displayed on the display section 34 (S229) according to the function information of the image forming apparatus 40. When the user has selected the print setting (S230), the control section 31 determines the storage site of the selection file (S231). If it is stored in the hand-held device 30, the control section 31 sends the print setting information and real data of the selection file to the AR server 20 (S232). If it is stored in the common server, the control section 31 sends the print setting information and path information of selection file information to the AR server 20 (S233), and the AR server 20 acquires the file from the common server in conformity to the path information (S234). After that, the AR server 20 creates a PCL file (S235), and transfers it to the image forming apparatus 40 (S236). The image forming apparatus 40 starts printing (S237).

As described above, after having shown the status information, the hand-held device 30 displays an operation panel so that the operation of the image forming apparatus 40 can be remote-controlled on this operation panel. Therefore, the hand-held device 30 gives a quick instruction to the image forming apparatus 40 in the standby mode. This arrangement substantially enhances the user convenience.

The present invention is not restricted to the aforementioned examples. The configuration or control of the present invention can be suitably modified, without departing from the spirit of the invention.

For example, the aforementioned example illustrates the case where the status information of image forming apparatuses 40 is displayed. The same procedure can also be applied to any desired managed apparatuses capable of appropriate processing by means of identification of the apparatus status.

The embodiment of the present invention can be applied to a hand-held device for displaying the information of an apparatus to be managed, a method for displaying the apparatus, and a method for remote control of the apparatus.

According to the hand-held device and apparatus management method as an embodiment of the present invention, intuitive understanding of the statuses of image forming apparatuses can be achieved. This is because the hand-held device screen shows the status information of the image forming apparatus located around a hand-held device and in a specific direction of the hand-held device.

Further, according to the hand-held device and apparatus management method as one embodiment of the present invention, the maneuverability of an image forming apparatus can be enhanced. This is because an operation panel for selecting/setting the function of the image forming apparatus is displayed by performing a selecting operation on the status display portion of the image forming apparatus displayed on a hand-held device. This operation panel allows the image forming apparatus to be remote-controlled.

The aforementioned arrangement eliminates the need of a user moving toward the image forming apparatus, and permits the user to identify the statuses of the image forming apparatuses located at a physically invisible position, for example, beyond a wall. Further, even if the IP address or URL of the image forming apparatus is known, the aforementioned arrangement ensures the image forming apparatus to be operated. This provides a substantial enhancement of the maneuverability.

Further, the image forming apparatus can be operated on the screen of the hand-held device. This structure minimizes the risk of a confidential document or password being peeped at by others, as in the case of operating on the panel of an image forming apparatus.

What is claimed is:

1. A hand-held device comprising:
a display section;
a position identifying section for identifying a position of the hand-held device;
an orientation identifying section for identifying an orientation of the hand-held device; and
a control section which specifies a prescribed managed apparatus located within a prescribed range of distance from the hand-held device and in a specific direction of the hand-held device, based on information stored in advance on positions of one or a plurality of managed apparatuses, and which acquires status information indicating a status of the prescribed managed apparatus to display the status information on the display section.

2. The hand-held device of claim 1, further comprising:
an image pick-up section for capturing an image in the specific direction of the hand-held device,
wherein the control section controls the display section to display an image which has been formed by superimposing the status information on an image of the prescribed managed apparatus captured by the image pick-up section.

3. The hand-held device of claim 1,
wherein once the prescribed managed apparatus is not located within the prescribed range of distance from the hand-held device and in the specific direction of the hand-held device as a result of moving the hand-held device, the control section deletes the status information displayed on the display section.

4. The hand-held device of claim 1,
wherein after displaying the status information on the display section, the control section controls the display section to display an operation panel for operating the prescribed managed apparatus.

5. An apparatus management method for a system in which a hand-held device having a display section, one or a plurality of managed apparatuses and a server are connected with one another through a communication network, comprising the steps of:
(a) the server storing a table in which position information of the one or the plurality of managed apparatuses is described;
(b) the hand-held device identifying a position of the hand-held device and sending information on the position to the server;
(c) the server referring to the table to specify the managed apparatus located within a prescribed range of distance from the hand-held device and notifying the managed apparatus to the hand-held device;
(d) the hand-held device identifying an orientation of the hand-held device and specifying a prescribed managed apparatus located in a specific direction of the hand-held device among the managed apparatuses located within a prescribed range of distance from the hand-held device and;
(e) the hand-held device displaying status information on the display section after acquiring the status information indicating a status of the prescribed managed apparatus.

6. The apparatus management method of claim 5,
wherein the hand-held device further comprises an image pick-up section for capturing an image in the specific direction of the hand-held device, and
wherein, in the step (e), the hand-held device displaying on the display section an image which has been formed by superimposing the status information on an image of the prescribed managed apparatus captured by the image pick-up section.

7. The apparatus management method of claim 5,
wherein, in the step (e), the hand-held device deleting the status information displayed on the display section once the prescribed managed apparatus is not located within the prescribed range of distance from the hand-held device and in the specific direction of the hand-held device as a result of moving the hand-held device.

8. The apparatus management method of claim 5, further comprising, in the step (e):
(e1) the hand-held device displaying an operation panel for operating the prescribed managed apparatus after displaying the status information on the display section; and
(e2) the hand-held device sending information on an instruction to allow the predetermined managed apparatus to perform a function designated on the operation panel.

9. An apparatus management method for a system in which a hand-held device having a display section, one or a plurality of managed apparatuses and a server are connected with one another through a communication network, comprising the steps of:
(a) the server storing a table in which position information of the one or the plurality of managed apparatuses is described;
(b) the hand-held device identifying a position and an orientation of the hand-held device and sending information on the position and the orientation to the server;
(c) the server referring to the table to specify a prescribed managed apparatus located within a prescribed range of distance from the hand-held device and in a specific direction of the hand-held device and notifying the prescribed managed apparatus to the hand-held device;
(d) the hand-held device displaying status information on the display section after acquiring the status information indicating a status of the prescribed managed apparatus.

10. The apparatus management method of claim 9,
wherein the hand-held device further comprises an image pick-up section for capturing an image in the specific direction of the hand-held device, and
wherein, in the step (d), the hand-held device displaying on the display section an image which has been faulted by superimposing the status information on an image of the prescribed managed apparatus captured by the image pick-up section.

11. The apparatus management method of claim 9,
wherein, in the step (d), the hand-held device deleting the status information displayed on the display section once the prescribed managed apparatus is not located within the prescribed range of distance from the hand-held device and in the specific direction of the hand-held device as a result of moving the hand-held device.

12. The apparatus management method of claim 9, further comprising, in the step (d):
(d1) the hand-held device displaying an operation panel for operating the prescribed managed apparatus after displaying the status information on the display section; and
(d2) the hand-held device sending information on an instruction to allow the predetermined managed apparatus to perform a function designated on the operation panel.

13. An apparatus management method for a system in which a hand-held device having a display section and one or a plurality of managed apparatuses are connected with each other through a communication network, comprising the steps of:
(a) the hand-held device storing a table in which position information of the one or the plurality of managed apparatuses is described;
(b) the hand-held device identifying a position and an orientation of the hand-held device and referring to the table to specify a prescribed managed apparatus located within a prescribed range of distance from the hand-held device and in a specific direction of the hand-held device; and
(c) the hand-held device displaying status information on the display section after acquiring the status information indicating a status of the prescribed managed apparatus.

14. The apparatus management method of claim 13,
wherein the hand-held device further comprises an image pick-up section for capturing an image in the specific direction of the hand-held device, and
wherein, in the step (c), the hand-held device displaying on the display section an image which has been formed by superimposing the status information on an image of the prescribed managed apparatus captured by the image pick-up section.

15. The apparatus management method of claim 13,
wherein, in the step (c), the hand-held device deleting the status information displayed on the display section once the prescribed managed apparatus is not located within the prescribed range of distance from the hand-held device and in the specific direction of the hand-held device as a result of moving the hand-held device.

16. The apparatus management method of claim 13, further comprising, in the step (c):
(c1) the hand-held device displaying an operation panel for operating the prescribed managed apparatus after displaying the status information on the display section; and
(c2) the hand-held device sending information on an instruction to allow the predetermined managed apparatus to perform a function designated on the operation panel.
